(19) United States
(12) Patent Application Publication
(10) Pub. No.: US 2019/0188305 A1
(43) Pub. Date: Jun. 20, 2019

(54) SPATIAL AND TEMPORAL DATA STORAGE AND RETRIEVAL

(71) Applicant: Conduce, Inc., Carpinteria, CA (US)

(72) Inventors: John R. Maschmeyer, O'Fallon, MO (US); Ryan P. Clancey, Monrovia, CA (US); Charles G. Law, Los Angeles, CA (US); Corey A. Porter, Monrovia, CA (US); Michael R. Sullivan, St. Louis, MO (US); Kevin M. Van Leer, Washington, MO (US)

(21) Appl. No.: 15/844,209

(22) Filed: Dec. 15, 2017

(51) Int. Cl. G06F 17/30; G06F 3/06

(52) U.S. Cl. CPC G06F 17/30551; G06F 17/30312; G06F 17/30525; G06F 3/0611

(57) ABSTRACT

Aspects of the current subject matter relate to a data storage and retrieval system that employs a data storage structure in which user data is spatially and temporally stored and fetched in real-time, allowing users to utilize and visualize the data. The data storage structure provides for a structured query and retrieval mechanism and is optimized for low-latency read operations covering a temporal and spatial range, while also allowing for varying play rates and spatial zoom levels. The data storage structure incorporates various data stores for query retrieval based on user request criteria.

### BACKGROUND

There is a continual need for data storage and retrieval capabilities. Data storage and retrieval systems that allow for real-time data retrieval and low-latency read operations, that also allow for utilization and visualization of stored data, are desired.

### SUMMARY

Aspects of the current subject matter relate to spatial and temporal data storage and retrieval.

A method, in accordance with an implementation of the current subject matter, includes receiving, by a processing device associated with a storage structure, a storage request including samples from a user device in communication with the processing device. The processing device stores, in a database table of the storage structure, a transaction that includes a transaction structure representing the storage request and including a list of the samples. The processing device processes the transaction to enable subsequent user read operations. The processing includes dividing the samples into one or more tiles according to criteria based upon spatial and/or temporal factors of the samples and the one or more tiles; in response to a determination that, for a given one of the one or more tiles, a number of samples exceeds a predefined threshold, compositing the number of samples in the given one of the one or more tiles; and storing, in the storage structure, the composited number of samples.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 is a block diagram representation of a system in which spatial and temporal data storage and retrieval consistent with implementations of the current subject matter may be implemented;

FIG. 2 is a flowchart illustrating a method related to aspects of processing a transaction in a transaction store consistent with implementations of the current subject matter;

FIG. 3 is a flowchart illustrating a method related to aspects of temporal compositing consistent with implementations of the current subject matter;

FIG. 4 is a flowchart illustrating a method related to aspects of spatial compositing consistent with implementations of the current subject matter;

FIG. 5 is an exemplary depiction illustrating aspects related to subdividing samples consistent with implementations of the current subject matter;

FIG. 6 is a flowchart illustrating a method related to aspects of reading tiles consistent with implementations of the current subject matter;

FIGS. 7-14 illustrate example results of read operations consistent with implementation of the current subject matter;

FIG. 15 is a flowchart illustrating a method related to aspects of processing a transaction in an entity store consistent with implementations of the current subject matter;

FIG. 16 is a flowchart illustrating a method related to aspects of reading from an entity store consistent with implementations of the current subject matter;

FIG. 17 is a flowchart illustrating a method related to aspects of writing to a metadata store consistent with implementations of the current subject matter;

FIG. 18 is a flowchart illustrating a method related to aspects of reading from a metadata store consistent with implementations of the current subject matter; and

FIG. 19 is a flowchart illustrating overall processing of a transaction consistent with implementations of the current subject matter.

When practical, similar reference numbers denote similar structures, features, or elements.

### DETAILED DESCRIPTION

Aspects of the current subject matter relate to a data storage and retrieval system that employs a data storage structure in which user data is spatially and temporally stored and fetched in real-time, allowing users to utilize and visualize the data. The data storage structure, in accordance with implementations of the current subject matter, provides for a structured query and retrieval mechanism and is optimized for low-latency read operations covering a temporal and spatial range, while also allowing for varying play rates and spatial zoom levels. The data storage structure incorporates data stores for query retrieval and allows for easily changing and updating search and storage algorithms.

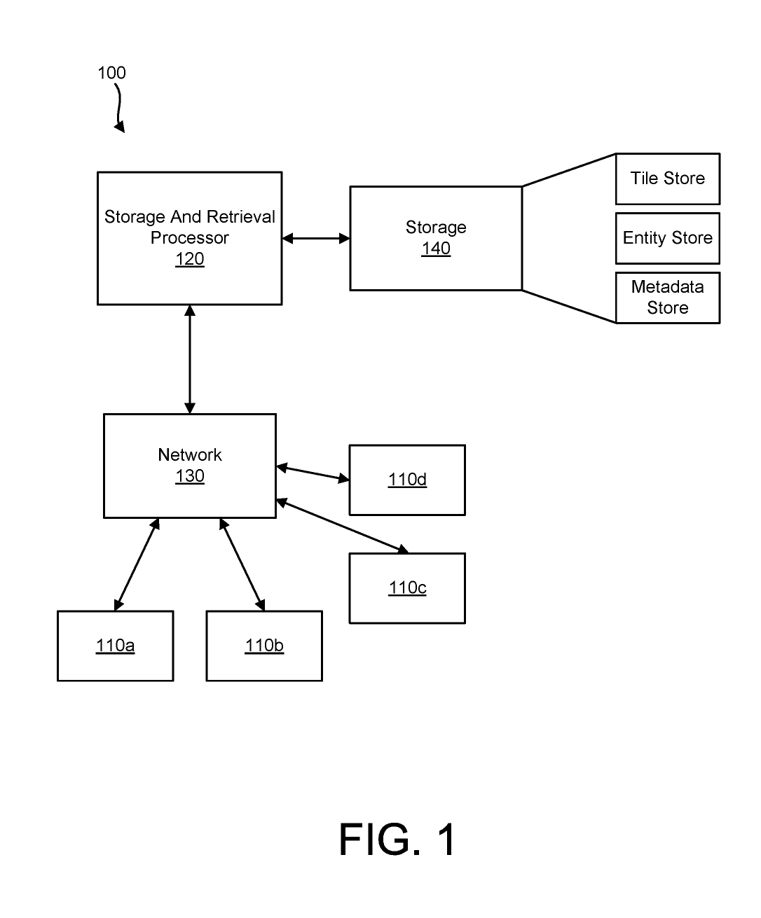

FIG. 1 is a block diagram representation of an exemplary system 100 in which spatial and temporal data storage and retrieval consistent with aspects of the current subject matter may be implemented. In particular, spatial and temporal data storage and retrieval may be implemented by the system 100.

With reference to FIG. 1, the system 100 includes one or more computing devices 110. Although four devices 110a,b,c,d are shown, the system 100 is not limited to any particular number. Moreover, each device 110 may include a plurality of processors, devices, systems, and/or networks, with each device 110 representing a particular user, customer, or group that has data to be stored and later retrieved. The devices 110a,b,c,d may be any type of mobile, handheld, laptop, desktop, or other device capable of receiving and transmitting data. The devices 110a,b,c,d connect to and are in communication with a spatial and temporal data storage and retrieval processor 120 (“storage and retrieval processor 120”). The devices 110a,b,c,d and the storage and retrieval processor 120 may communicate over a network or other connection (e.g., a wired or wireless connection), such as network 130. In some implementations, the network 130 may be the cloud, and the storage and retrieval processor 120 may be a server, including one or more processors, operating in the cloud. In other implementations, the storage and retrieval processor 120 may be a remote server including one or more processors. In other implementations, there may be a direct connection between the devices 110a,b,c,d and the storage and retrieval processor 120.

In accordance with implementations of the current subject matter described herein, the devices 110a,b,c,d provide data to the storage and retrieval processor 120. The storage and retrieval processor 120 stores the received data and subsequently retrieves the data for utilization and/or presentation to a corresponding one of the devices 110a,b,c,d. For example, a particular device 110a provides the storage and retrieval processor 120 with data, and later, upon the device 110a requesting the data or submitting a query (e.g., through one or more request instructions or signals, which may be user-driven, provided to the storage and retrieval processor 120 from the device 110a), the storage and retrieval processor 120 retrieves the data for utilization and/or presentation to the device 110a (e.g., to a user of the device 110a). Additionally, rather than a particular user requesting the data or initiating a query, the storage and retrieval processor 120 may compile reports, presentations, or the like relating to the data for transmission to the device 110a, which may be stored in the device 110a for later viewing, manipulation, and/or processing by the device 110a.

Storage 140 is associated with the storage and retrieval processor 120. The storage 140 may be separate and remote from the storage and retrieval processor 120 or may be integrated within the storage and retrieval processor 120. Alternatively, portions of the storage 140 may be integrated with the storage and retrieval processor 120 while other portions are remotely located. The storage 140 may be part of the cloud. The storage 140 includes multiple database tables in a defined storage structure to store the data provided by the devices 110a,b,c,d, consistent with implementations of the current subject matter as described herein. The defined storage structure of the storage 140 includes but is not limited to a tile store, an entity store, and a metadata store, consistent with some implementations of the current subject matter described herein.

In accordance with some implementations of the current subject matter described herein, an entity may be defined as a person, place, or thing that exists in space and time. An entity may be represented as a series of samples that define properties of that entity at a single instant in time. A sample may be represented by, for example, a JavaScript Object Notation (JSON) structure containing an ID, the sample time, the sample location, and any other properties that describe the entity at that instant in time. For example, a sample representing a real-time status of a package shipment may be represented as follows:

{

“id”: “shipment 1”,
“kind”: “ground”,
“time”: “2017-10-24T10:22:09+00:00”,
“point”: {

“longitude”: −91.571045,
“latitude”: 38.022131

},
“Value”: 102325.26,

“Status”: ″delivered″

}

In accordance with implementations of the current subject matter described herein, a dataset is a named collection of samples for one or more entities. In certain implementations, data storage and retrieval by the storage and retrieval processor 120 is indexed by dataset.

Implementations of the current subject matter provide a storage structure that achieves low-latency responses to various types of queries and/or requests. Sample data is stored in different formats in multiple database tables. The different representations of data are, in accordance with some implementations, completely transparent to the end user (e.g., the end user has access to each of the different representations of data). In accordance with other implementations, the different representations of data may be semi-transparent to the end user (e.g., the end user is able to see portions of the different representations of data) or nontransparent to the end user.

The transaction store holds unmodified user requests (“transactions”). Storage requests may begin by the request, received by the storage and retrieval processor 120, being directly stored into the transaction store. Each request is represented by a transaction structure, which may contain, for example, an operation type, a list of samples, and/or a valid flag. Operation types may define what the user is intending to do with the specified samples; for example, inserting new samples, modifying existing samples, and/or removing existing samples. The valid flag is, as an example, a Boolean value set to true when the transaction is determined to contain well-formatted data and can thus be processed into the other data stores. Invalid transactions (e.g., the Boolean value set to false) may be visible within the transaction store, but since their data cannot be processed, they are not represented within other data stores, according to some implementations.

A transaction is stored in a database table, along with a sequence number. Each sequence number/transaction value is stored in a separate row within the database table. Transactions may be stored in a compacted binary form in a single database column. Sequence numbers are represented with an integer column.

All transactions are, according to some variations of the current subject matter, applied in order. Transactions are generally unmodifiable: users may view the contents of the transaction store and create new transactions, but they may not alter an existing transaction.

After a transaction has been added to the transaction store, an asynchronous job begins to apply that transaction to the downstream stores, further described herein. The first step of the asynchronous job is, according to one aspect of the current subject matter, to validate the transaction. While an initial validation may be performed during the user request (resulting in the Boolean value of the valid flag in the transaction structure), a subsequent, more thorough validation can optionally be made. The initial validation is performed before responding to the user request and thus is preferably completed within a short time period. The subsequent validation stage is performed asynchronously and may require that users poll the status of the operation to determine when/if it has been completed. The subsequent validation process may be unique for each type of transaction operation, but it may typically involve checking the existing data to determine whether or not the selected or identified operation types are legal. For example, it is not valid (e.g., legal) to remove a sample that was never added in the first place.

After the second, subsequent validation of the transaction, the transaction is applied to a tile store, in accordance with implementations of the current subject matter. The tile store allows for efficient access to a range of data covering a spatial and temporal range. Within the tile store, samples are divided into tiles and indexed based upon the tile's location in space and time. The tile store is optimized for low-latency read operations covering a temporal and spatial range while also allowing for varying play rates and spatial zoom levels. The dividing of the samples into one or more tiles is in accordance with criteria relating to spatial and/or temporal factors of the samples and the tiles, as further described herein.

A tile is represented as an array of samples, stored in a compact binary format, and indexed by a tile index. A tile index is a set of integers specifying the tile's location. For example, a set of four integers may specify the tile's location in the x, y, z, and time dimensions. Additionally, two more integers may be used to specify the tile's spatial and temporal zoom levels. These integers may be combined to define an example of the index for the tile data.

In accordance with implementations of the current subject matter, the spatial and temporal zoom levels define the size of a tile. In some variations, spatial zoom level “0” is defined such that each tile is 360.0 units wide (the width of the earth in degrees longitude). Each zoom level above that yields a tile half as wide. For example, spatial zoom level “1” is 180.0 units wide, and spatial zoom level “2” is 90.0 units wide. Negative spatial zoom levels are also allowed. Spatial zoom level “−1” is 720.0 units wide. Temporal zoom level is defined similarly. In some variations, temporal zoom level “0” is defined to be one year in width. Temporal zoom level “1” is thus one half of a year, and temporal zoom level “−1” is two years. Positions in space and time can be converted into tile indices using the width of the tile. Tile indices can be negative. These particular spatial and temporal zoom level definitions defined herein are merely exemplary, and other spatial and temporal zoom level definitions may be applied. Selection of the base tile size is driven by the desired spatial and temporal ranges to be represented within the tile store, as well as the constraints of the computing environment's representation of numbers. For example, representing timespans spanning the life of the universe (billions of years) would yield significantly different tile sizes than representations for the life of a subatomic particle (tiny fractions of a second).

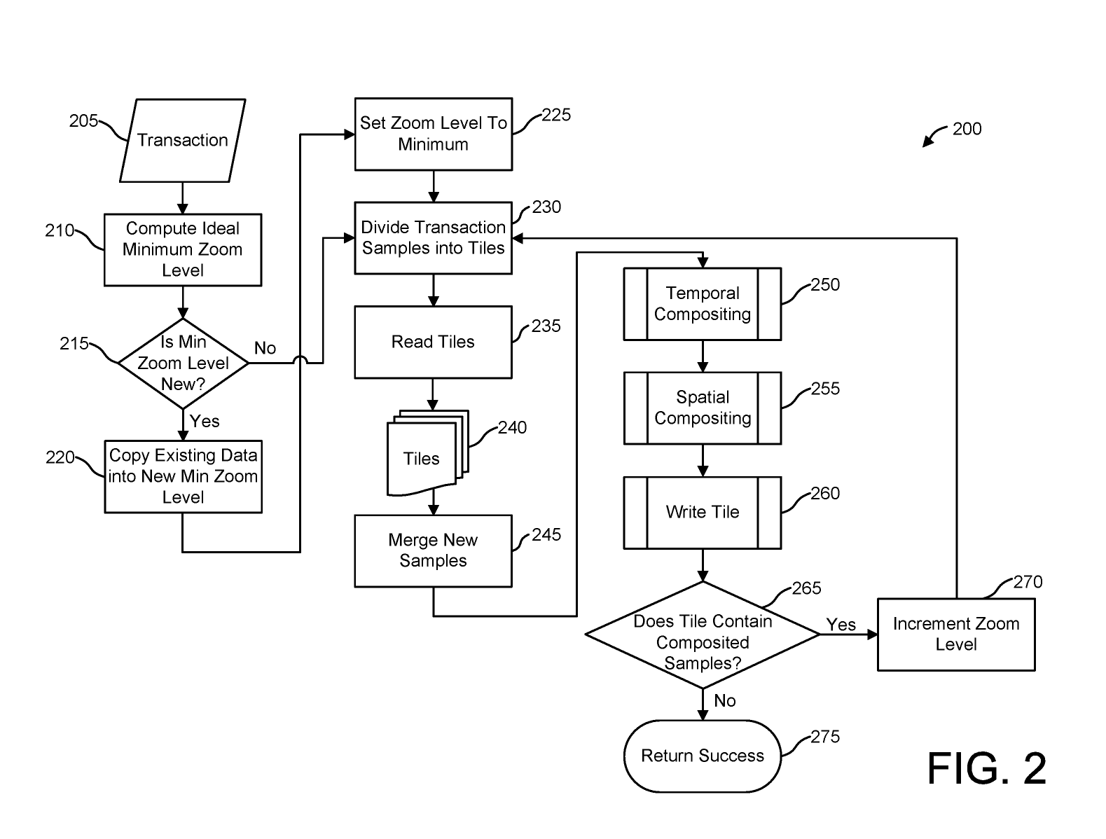

With reference to FIG. 2, a process flowchart 200 illustrates features of a method related to aspects of processing a transaction in a tile store, which may optionally include some or all of the following. When loading data into the tile store, each transaction 205 may be processed sequentially. Processing begins at 210 by computing the ideal minimum zoom level for the entire dataset. The ideal minimum zoom level may be defined to be the spatial and temporal zoom levels at which all samples could fit within a single tile. If these zoom levels are less than the current minimum levels (as determined at 215; e.g., the determined ideal minimum zoom level is new), existing data is copied from the current top-level tiles (those tiles at the current minimum zoom levels) into new top-level tiles at the new minimum zoom levels (at 220). At 225, the zoom level is set to the new minimum zoom level value.

If the determined zoom levels are not less than the current minimum levels (as determined at 215; e.g., the determined ideal minimum zoom level is not new), then the process skips 220 and 225 and continues at 230.

After ensuring tiles exist at the minimum zoom level, at 230, the samples from the new transaction are divided into separate tiles at the minimum zoom levels and each tile is updated. Updates may be accomplished by reading the existing tile (at 235) (e.g., resulting in tiles 240) and merging new samples at 245. The merging of new samples may include adding the new samples to the sample list, and writing the updated sample list back into the database.

When the number of samples in a single tile becomes too large, latency of reading that tile becomes high as well. In order to provide users with the minimum possible read latency, in accordance with implementations of the current subject matter, two actions may be taken: 1. The samples within a tile are composited; and 2. The tile is subdivided into multiple tiles at a higher spatial and/or temporal zoom level.

“Too large” may be defined by the read latency of the underlying database, which directly correlates with the size of the represented tile data (e.g., in bytes). The number of samples contained within the tile can be used as an approximation to this size. A threshold value of 8,000 samples, for example, could be used to determine when a tile has become too large. Other threshold values can also be utilized.

Compositing algorithms, in accordance with implementations described herein, may be applied based on a quantity of samples in a given tile. When the number of samples in a tile exceeds a predefined number, then compositing is done to maintain performance, thus reducing sample count. Anytime a tile is composited, it is subdivided at a different zoom level (e.g., each dimension is divided in half as needed). The subdivided tiles are used on the read operation side: when a user requests data spanning a particular spatial range and temporal range/play rate. The correct choice of zoom level at which to look for data is computed (e.g., determine which zoom levels exist at a dataset and correlate those to minimize the number of tiles read).

According to implementations of the current subject matter, compositing is the process of reducing the number of samples being written into a tile by combining some of the samples in an intelligent manner. Implementations of the current subject matter provide two forms of compositing: temporal compositing and spatial compositing.

In temporal compositing, samples are filtered so that the rate of updates to a given entity does not exceed a given threshold. This threshold is determined by the temporal zoom level. As the temporal zoom level decreases, the update frequency also decreases. As a result, data stored in low temporal levels is best suited for high play rates, in which users would not be able to perceive all of the individual updates to the entities.

In an example implementation, the threshold may be set to 30 Hz. That is, no entity will have more than 30 samples per second at the user's specified play rate. This prevents data from being queried at a rate higher than the rate at which the user can reasonably view it. For example, if a user queries for data spanning a 10 second time range at a play rate of twice real-time, the resulting data will be viewed in a span of five seconds. Thus no more than 30*5=150 samples should be returned for any entity. The temporal zoom level for the request is thus set to ensure that there are approximately 150 samples over the requested time range.

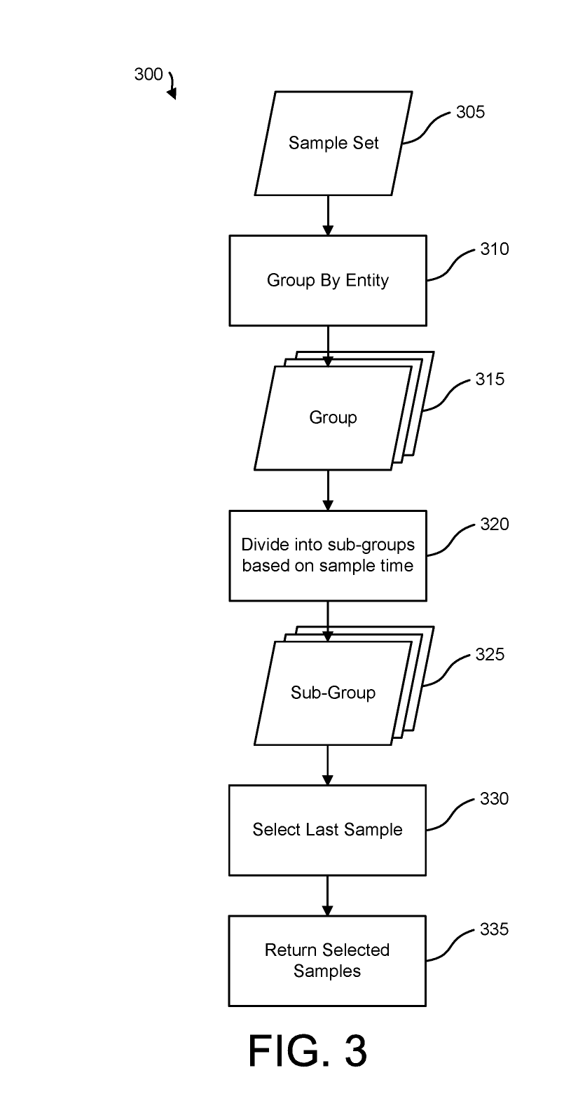

With reference to FIG. 3, a process flowchart 300 illustrates features of a method related to aspects of temporal compositing, which may optionally include some or all of the following. Samples in a sample set 305 are grouped by entity at 310, resulting in groups 315. That is, all samples with the same identifier are put into a group and sorted by time. At 320, for each group 315, the samples are divided into N sub-groups 325 based on the sample time. At 330, for each sub-group 325, the last sample from the group is selected and the remaining samples are discarded. At 335, the set of selected samples are returned in place of the original sample list.

In accordance with some implementations of the current subject matter, if temporal compositing does not reduce the number of samples enough, spatial compositing may also be performed. In spatial compositing, samples are combined based on location. The spacing of the combined samples is determined by the spatial zoom level. As the spatial zoom level decreases, the distance between compositing points increases. As a result, data stored in low spatial zoom levels is best suited for large spatial regions in which it is difficult for a user to distinguish many individual data points. Spatial compositing, in accordance with implementations of the current subject matter, allows for highly dense datasets when zoomed out and played at high rates.

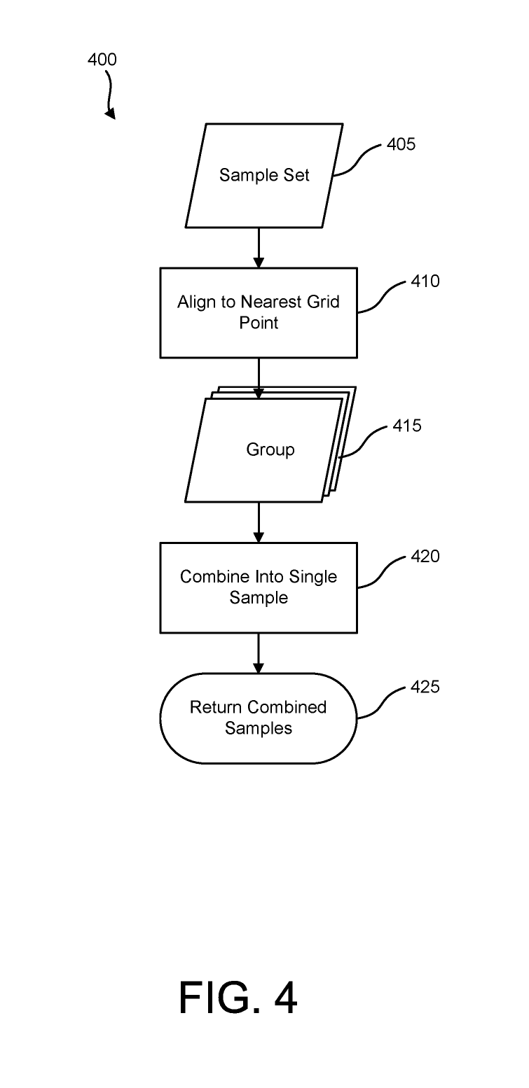

With reference to FIG. 4, a process flowchart 400 illustrates features of a method related to aspects of spatial compositing, which may optionally include some or all of the following. At 410, each sample in the tile's sample set 405 is placed in a group associated with the nearest grid point (the tile is divided into fixed grid points in the x, y, and z dimensions), resulting in groups 415. At 420, at each grid point, all samples are combined into a single sample by merging properties of the samples. This resulting list of merged samples is used in place of the original sample list (return combined samples at 425).

Referring again to FIG. 2, temporal compositing (if required) and spatial compositing (if required), as described above consistent with implementations of the current subject matter, are performed at 250 and 255, respectively. Following the compositing processes, at 260, new tiles are written. At 265, a determination is made as to whether a new tile contains composited samples. If the determination is yes, then at 270, the zoom level is incremented and the process proceeds to 230 for the samples to be divided into separate tiles at the minimum zoom levels and for the tiles to be updated. At 275, if the determination is no as to whether a new tile contains composited samples, then the process ends with a successful processing of a transaction.

If it is determined that compositing is necessary to reduce the size of a single tile, that tile is subdivided in either or both the spatial or temporal dimension. If temporal compositing results in a reduction of the sample set, the original sample set (before compositing was applied) is inserted into a new tile at a temporal zoom level one higher than the current temporal zoom level. This results in up to two new titles being created, each covering one half the time range of the original tile. These new tiles may be referred to herein as “children” of the original tile. The original tile may be referred to herein as the “parent” of the new tiles. The children tiles may be written following the same process that was used to create the parent tile. That is, the sample set will be divided into tiles. These may be composited and thus may lead to further subdivision. Since each child tile only covers one half the time range, the number of samples that need to be written to the tile are on average half as many as in the parent tile. This may yield tiles in which no compositing is required, and thus prevent further subdivision. If one of the tiles contains more entities than the other, further compositing may be required, leading to further subdivision. This process may continue until no further subdivision is required, no further subdivision is possible, or a maximum temporal zoom level has been reached.

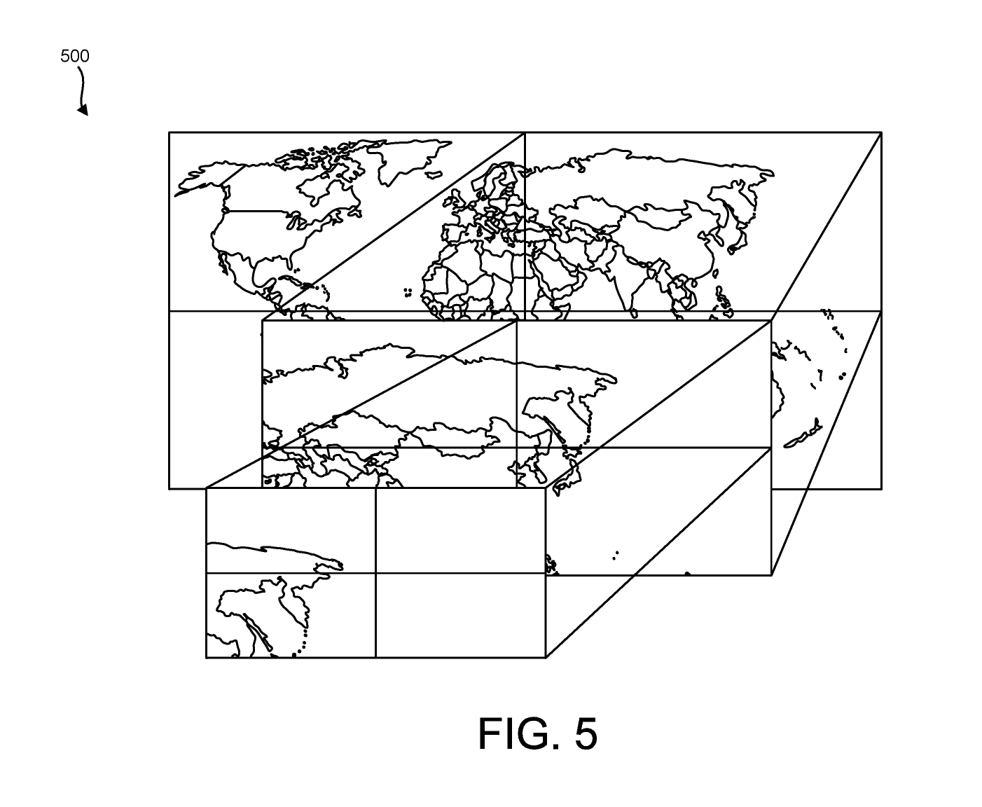

FIG. 5 provides a diagram 500 illustrating the concept of spatial subdivision. If spatial compositing results in a reduction of the sample set, the tile is also subdivided spatially. For spatial subdivision, the spatial zoom level is incremented, causing the width of each tile to be cut in half. This occurs along all three spatial dimensions, resulting in up to eight additional tiles being generated. The sample set from the parent tile is divided across these eight children tiles and written using the same process. Once again, this may yield further compositing and thus further subdivision. Spatial subdivision may stop when no compositing is required, no further subdivision is possible because the remaining samples are collocated, and/or a maximum zoom level has been reached.

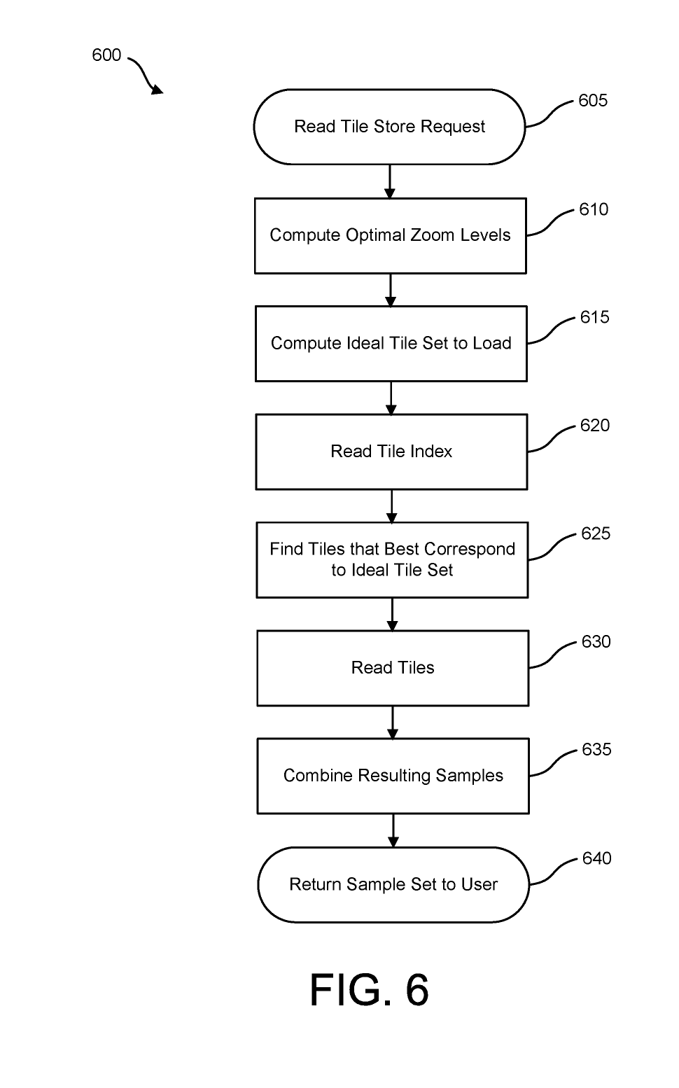

As previously described, the tile store is optimized for low latency read operations. A user (e.g., one of the devices 110a,b,c,d or a user thereof) may provide a time range, a spatial range, a play rate, and/or a spatial zoom level as inputs. The tile store then operates, as described herein, to return a list of samples that cover at least the specified range. The correct set of tiles to read must first be computed to return the list of samples. With reference to FIG. 6, a process flowchart 600 illustrates features of a method related to aspects of reading tiles in response to a user request, which may optionally include some or all of the following. A read tile store request 605 is received (e.g., by the storage and retrieval processor 120). At 610, the optimal zoom levels are computed. Given the play rate and the time span, the correct temporal zoom level may be computed. This level may be the ideal level to align the play rate to the number of temporally composited sample bins within a tile, or, if that level would yield too many tiles to read for a low latency operation, a level that will yield the maximum allowed number of tiles to cover the entire request. Similarly, a spatial zoom level is computed using the user-provided zoom level to determine the best spatial level to provide, and then limiting this if the spatial range would yield too many tile reads for low latency requests.

At 615, after the zoom levels have been determined, the set of tiles to read is computed. This includes the set of tiles at the ideal zoom levels that completely covers the user-requested temporal and spatial ranges.

Due to the approach taken, consistent with implementations described herein, to store data in tiles, some tiles may be subdivided into tiles at higher zoom levels while others may not have such a subdivision. As a result, the system must map the ideal tiles to read to the actual tiles in the dataset. This may be achieved by maintaining a tile index for each dataset. The tile index specifies which tiles are contained in the dataset. At 620, the tile index is read. At 625, each of the ideal tiles is mapped to its best corresponding tile, if any, using this index. After finding the list of best corresponding tiles, the list may be filtered to remove potential duplicates.

At 630, the tiles are read from the resulting list. At 635, the results are combined into a single list of samples, which are returned to the user (640).

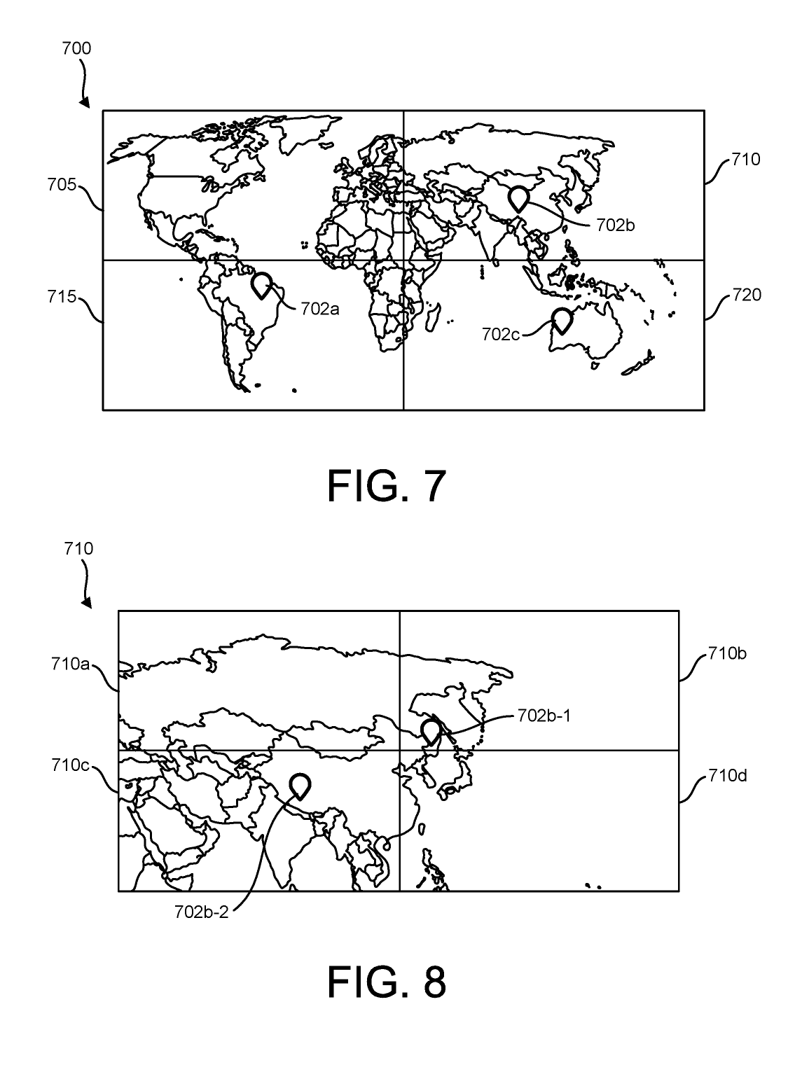

FIGS. 7-14 illustrate example results of read operations consistent with implementation of the current subject matter. The examples illustrate how the results of a read operation differ in various situations. In each of the examples in FIGS. 7-9, the effect is demonstrated in only two spatial dimensions, but it is understood that the tile store allows for three spatial dimensions. As illustrated in various examples of FIGS. 7-14, when data is clustered in a particular region and a user is zoomed out, most of the data is non-composited and the remaining data is composited in a high-density cluster. As a user zooms in, the data is broken out into less and less composited structures until the original data is shown.

In FIG. 7, diagram 700 illustrates spatial compositing and tile subdivision. Several samples 702a,b,c are shown spanning a four tile region, tiles 705, 710, 715, 720. Samples in each tile are composited into a single sample, indicating that zooming-in may show more detail.

FIG. 8 illustrates a zoomed-in region of the upper-right quadrant (i.e., tile 710) of FIG. 7. In this example, single tile 710 is subdivided into four new spatial tiles, 710a,b,c,d. As a result, the single composited sample 702b is split into two samples 702b-1 and 702b-2. The sample 702b-1 in the upper right (tile 710b) is a single, non-composited sample, indicating that no more subdivision of that tile 710b is necessary. The upper left and lower right areas (tiles 710a and 710d) have no samples. These tiles are empty and thus no subdivision is required. The tile 710c in the lower left has a single composited sample 702b-2, and thus further subdivision is required.

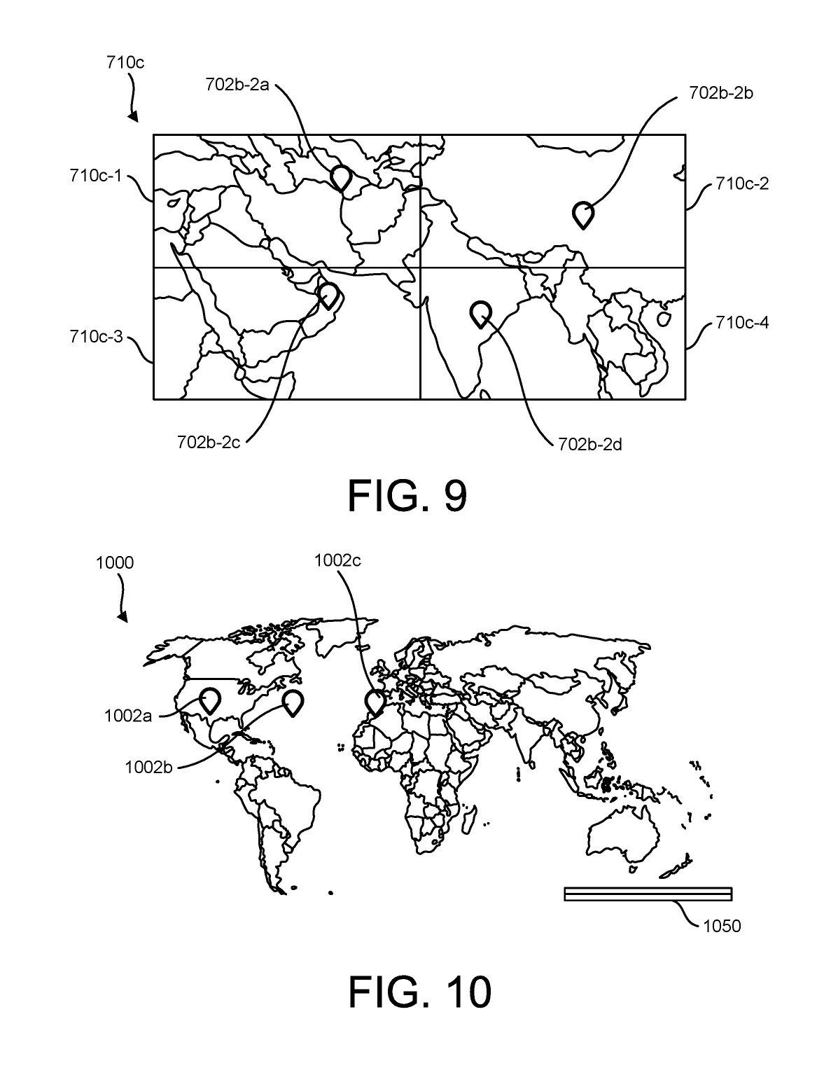

FIG. 9 illustrates a zoomed-in region of the lower left quadrant (i.e., tile 710c) of FIG. 8. The tile 710c is subdivided into four tiles, 710c-1,c-2,c-3,c-4. Now there are four individual samples, 702b-2a,b-2b,b-2c,b-2d, one in each tile. As a result, no further subdivision occurs.

The series of examples in FIGS. 10-14 demonstrate temporal zoom levels. These illustrations follow a few conventions. First of all, it is assumed that all samples shown are samples of the same underlying entity. Next, a timeline is shown in the lower right corner to indicate the time span covered by the image. In a typical application, the contents of the visualization would change over time. To help illustrate in a single image, these pictures show a time slice that contains multiple data points that would ordinarily not be seen simultaneously. The entity being displayed is moving from left to right as time moves forward. Thus, in a single time slice, several sample points can be seen along its path. Since temporal zoom level is a function of both time span and play rate, it is assumed that the two are directly related in these images. As the time span is decreased to a smaller time window, the play rate is also decreased.

In FIG. 10, a single tile 1000 spanning the entire time range 1050 is shown. In this tile 1000, only a few samples 1002a,b,c are visible because the samples are temporally composited. Only a single sample is selected for each time bin within the tile.

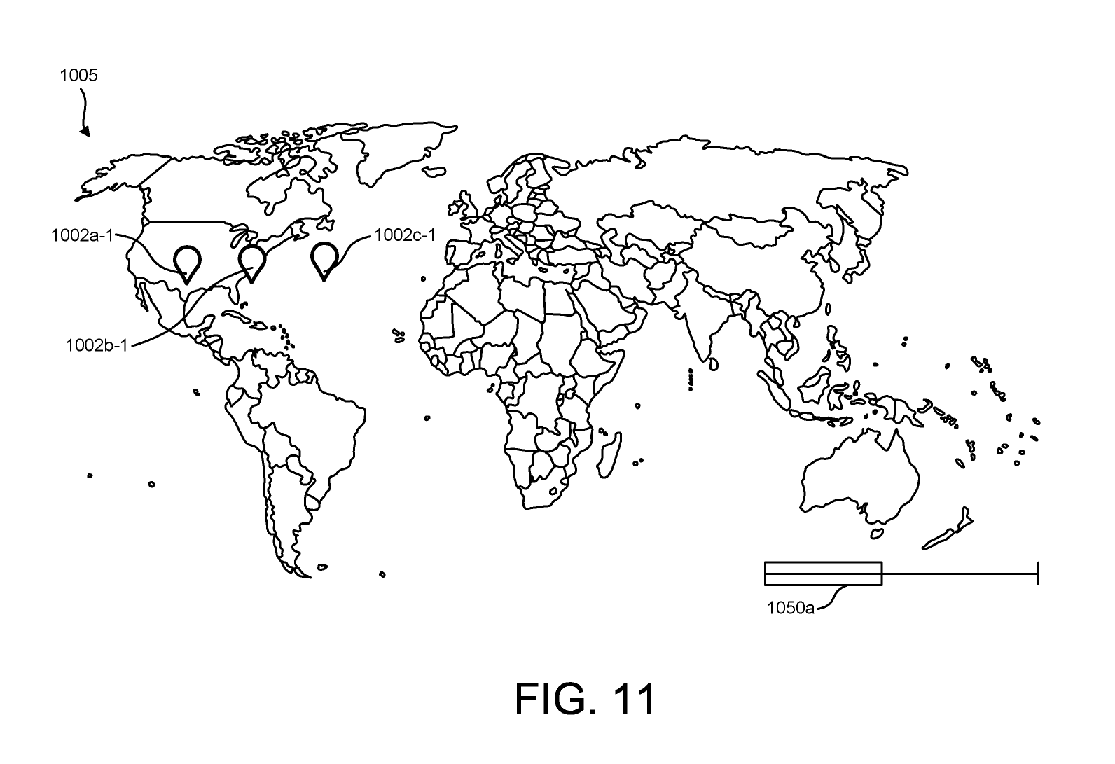

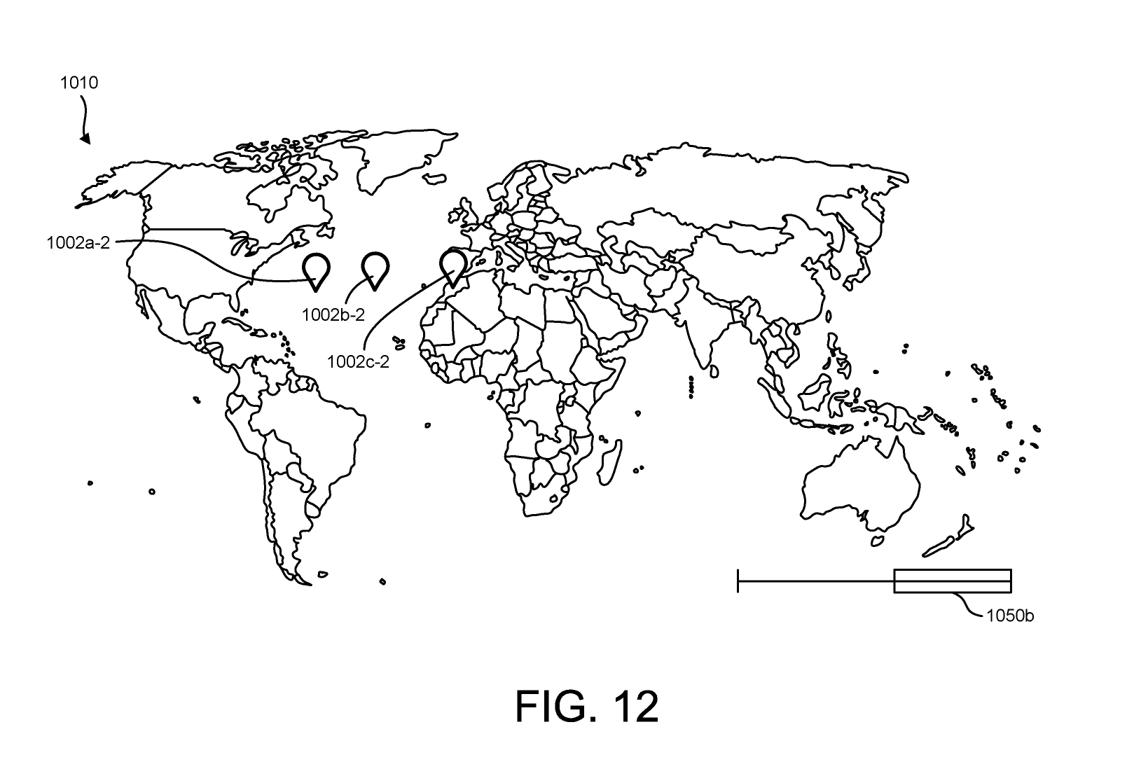

When the tile 1000 from the previous image is subdivided, two new tiles 1005 and 1010, each covering one half (1050a,b) the total time range 1050, are created as shown in FIGS. 11 and 12, respectively. As can be seen in FIGS. 11 and 12, each tile 1005 and 1010 contains the same number of time bins, and thus the same number of samples (three) per tile (samples 1002a-1,b-1,c-1 in tile 1005 and samples 1002a-2,b-2,c-2 in tile 1010). This leads to twice as many samples as in the previous example. When played at one half the play rate, samples will update at the same frequency with double the resolution.

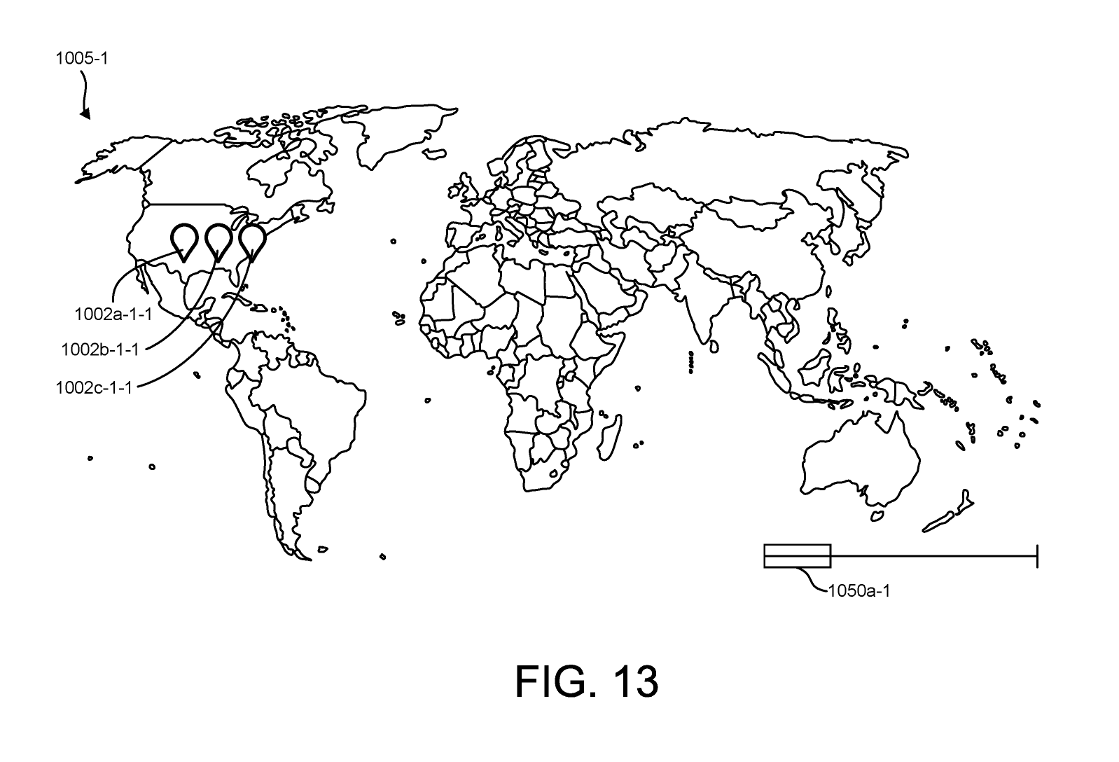

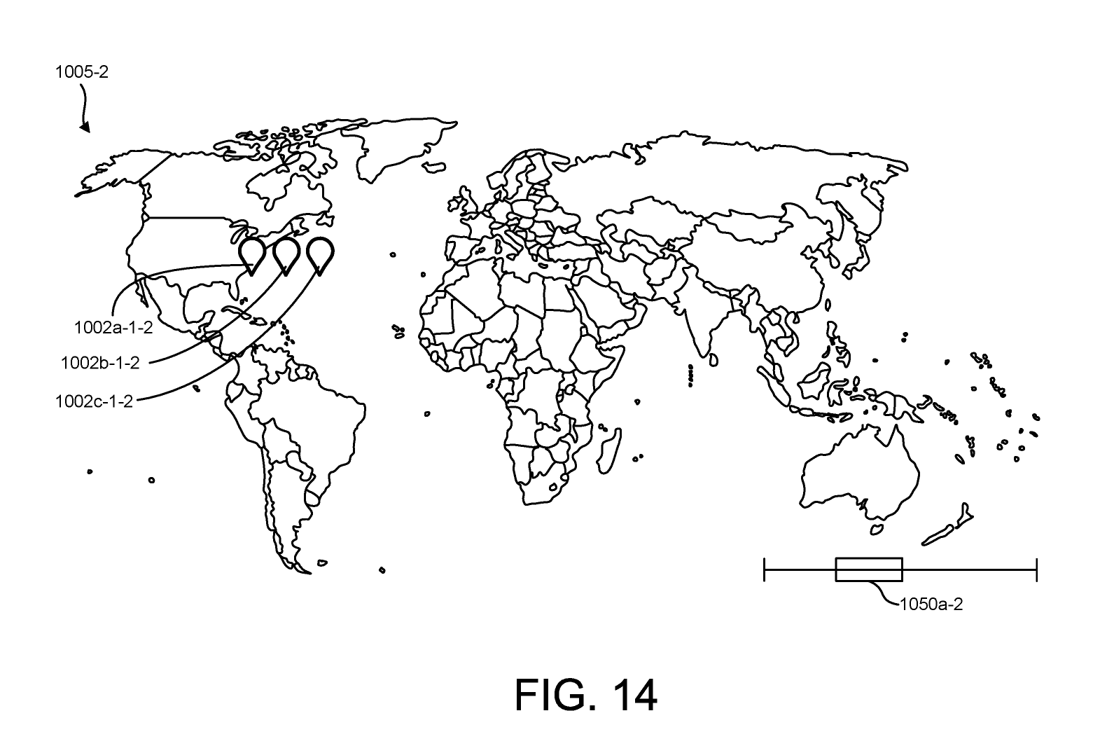

When the tile 1005 from the previous image is subdivided, two new tiles 1005-1 and 1005-2, each covering one half (1050a-1,a-2) of the total time range 1050a, are created as shown in FIGS. 13 and 14, respectively. As can be seen in FIGS. 13 and 14, each tile 1005-1 and 1005-2 contains the same number of time bins, and thus the same number of samples (three) per tile (samples 1002a-1-1,b-1-1,c-1-1 in tile 1005-1 and samples 1002a-1-2,b-1-2,c-1-2 in tile 1005-2). Once again, the resolution of the samples has doubled. If the play rate is halved, the update frequency will remain unchanged.

Returning back to the overall processing of the transaction, and the asynchronous job applying the transaction to the downstream stores, after being processed in the tile store, the transaction is applied to an entity store, in accordance with implementations of the current subject matter. The entity store allows for efficient access to all samples of a specific entity. Samples are stored in a compressed binary form in a table indexed by the identifier and time fields. Each sample from a transaction is added as a new row in this table, replacing the prior sample if necessary.

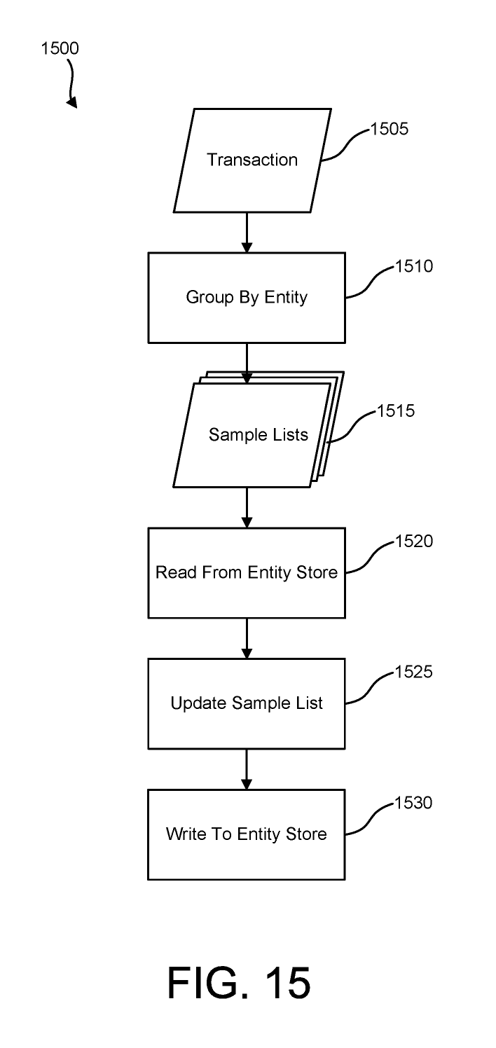

With reference to FIG. 15, a process flowchart 1500 illustrates features of a method related to aspects of processing a transaction in an entity store, which may optionally include some or all of the following. A transaction 1505 is grouped by entity at 1510, resulting in sample lists 1515. At 1520, the entity store is read, and at 1525, the sample list is updated. This update is used to write to the entity store at 1530.

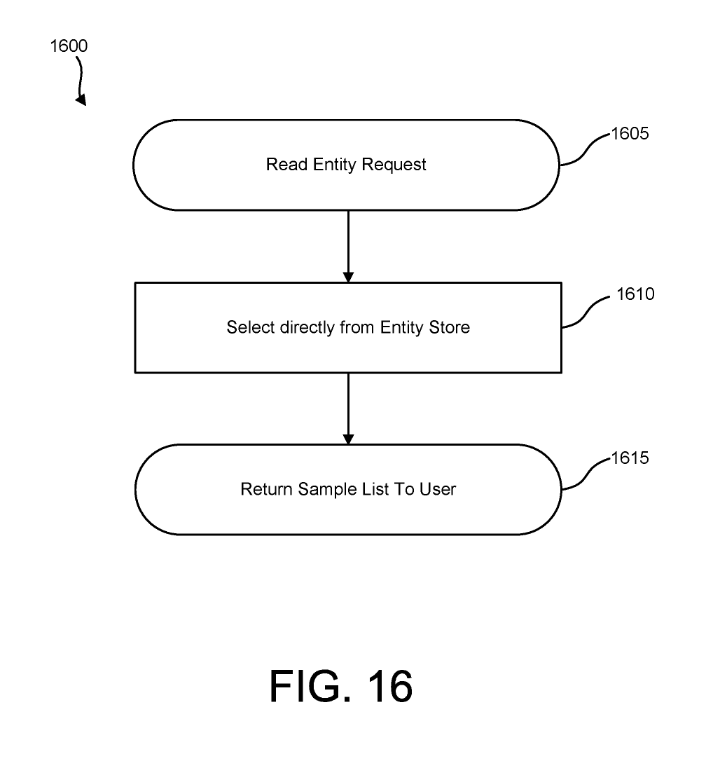

Reading from the entity store requires an entity identifier and optionally a specific time. Queries are direct database lookups. With reference to FIG. 16, a process flowchart 1600 illustrates features of a method related to aspects of reading from an entity store, which may optionally include some or all of the following. At 1605, an entity request is read. At 1610, a selection directly from the entity store is made, based on the entity request. And at 1615, the sample list is returned to the user.

After being processed in the entity store, the transaction is applied to a metadata store, in accordance with implementations of the current subject matter. The metadata store holds useful statistics about a dataset. The statistics contain information of general interest, such as the absolute minimum and maximum temporal and spatial bounds. Metadata may be stored in a single database table. Metadata for a dataset may be represented by a single record in that table, with each column representing a specific statistic.

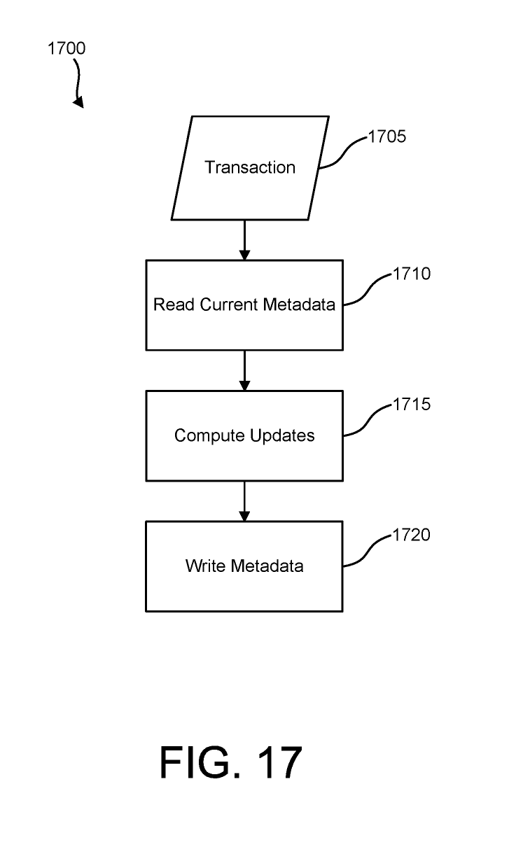

With reference to FIG. 17, a process flowchart 1700 illustrates features of a method related to aspects of writing to a metadata store, which may optionally include some or all of the following. With a transaction 1705, metadata is written by first reading the existing metadata for the dataset (at 1710) and then computing updates to it for the given transaction 1705 (at 1715). These updates are then written back into the database, replacing the old values (at 1720).

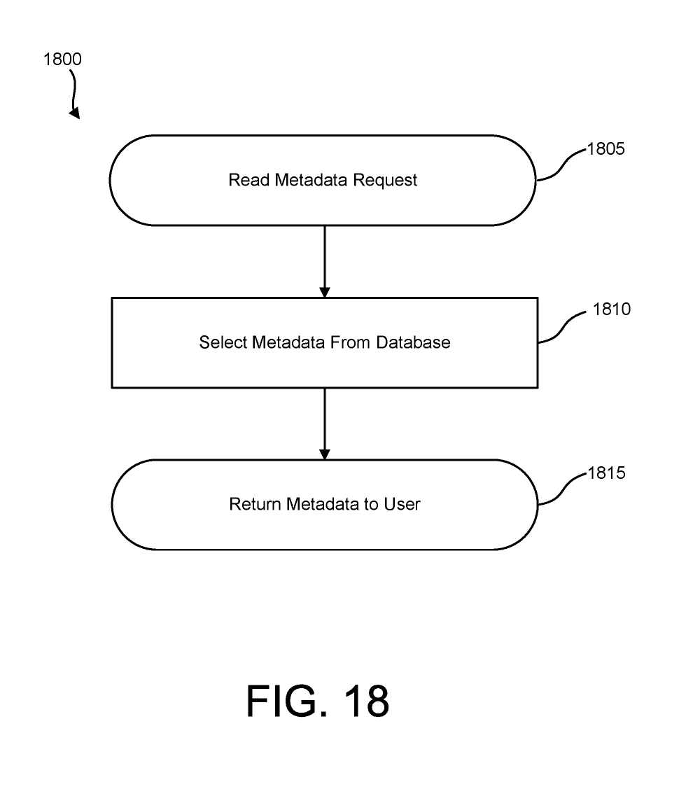

Reading metadata requires the identifier of the dataset. This identifier is used to fetch the corresponding record from the database, which is then returned to the user. With reference to FIG. 18, a process flowchart 1800 illustrates features of a method related to aspects of reading from a metadata store, which may optionally include some or all of the following. At 1805, a metadata request is read. At 1810, a selection directly from the metadata store is made, based on the metadata request. And at 1815, the metadata is returned to the user.

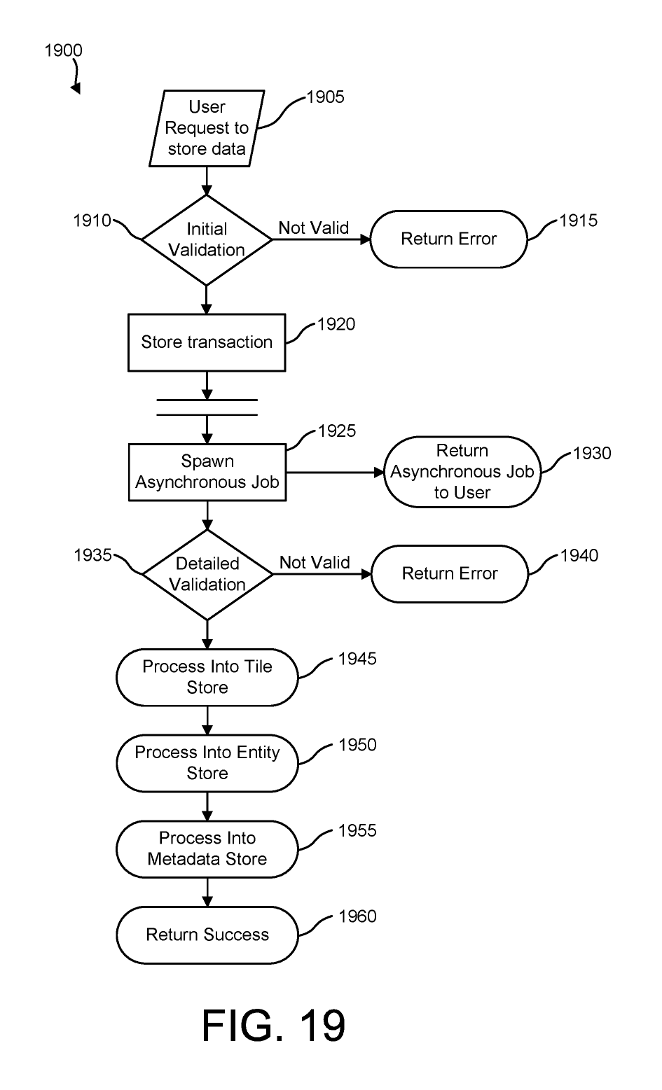

Now turning to FIG. 19, a process flowchart 1900 illustrates features of the overall processing of a transaction consistent with implementations of the current subject matter, which may optionally include some or all of the following.

At 1905, a storage request from a particular device 110a,b,c,d is received by the storage and retrieval processor 120.

At 1910, the storage and retrieval processor 120 performs an initial validation on the storage request. The initial validation serves to determine if the storage request contains well-formatted data and can thus be processed into the various data stores of the storage and retrieval processor 120. If the validation determination indicates that the storage request is not valid, an error is returned to the particular device 110a,b,c,d at 1915. If the validation determination indicates that the storage request is valid, a transaction structure representing the request is stored at 1920.

At 1925, after a transaction has been added to the transaction store, an asynchronous job begins. At 1930, the asynchronous job is returned to a user (e.g., a user of the particular device 110a,b,c,d or to the particular device 110a,b,c,d itself). That is, in some implementations, an identifier representing the asynchronous job may be returned to the user. This allows the user to poll for updates as to the status of that asynchronous job.

At 1935, a detailed validation, subsequent to the initial validation at 1910, of the transaction is performed. This subsequent validation stage is performed asynchronously and may involve checking the existing data to determine whether or not the selected or identified operation types are legal, for example. If the subsequent validation indicates that the transaction is not valid, an error is returned to the user at 1940.

If the transaction is determined to be valid at 1935, then at 1945 the transaction is processed in the tile store, consistent with implementations described herein. At 1950, the transaction is processed in the entity store, followed by processing in the metadata store at 1955, both of which are described herein.

At 1960, following the asynchronous job applying the transaction to the downstream stores, a success indication is returned to the user.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving, by a processing device associated with a storage structure, a storage request comprising samples from a user device in communication with the processing device;
storing, by the processing device in a database table of the storage structure, a transaction comprising a transaction structure representing the storage request, the transaction structure comprising a list of the samples;
processing, by the processing device, the transaction to enable subsequent user read operations, the processing comprising:
dividing the samples into one or more tiles according to criteria based upon spatial and/or temporal factors of the samples and the one or more tiles;
in response to a determination that, for a given one of the one or more tiles, a number of samples exceeds a predefined threshold, compositing the number of samples in the given one of the one or more tiles; and
storing, in the storage structure, the composited number of samples.

2. The method of claim 1, wherein the storing of the transaction is in response to an initial validation by the processing device that the storage request meets predefined criteria.

3. The method of claim 1, wherein the transaction structure further comprises one or more of an operation type and a valid flag.

4. The method of claim 1, further comprising:
performing, by the processing device and in response to the storing of the transaction, a validation analysis of the transaction, the validation analysis comprising a determination as to the validity of one or more operation types associated with the samples.

5. The method of claim 1, wherein the criteria based upon spatial and/or temporal factors comprises a minimum zoom level, wherein the minimum zoom level comprises a spatial zoom level and/or a temporal zoom level at which the samples fit within a single one of the one or more tiles.

6. The method of claim 1, wherein the processing of the transaction further comprises indexing each of the samples with a tile index, wherein the tile index comprises a set of integers specifying, for a given tile corresponding to a particular one of the samples, one or more of a location of the given tile, a time dimension of the given tile, a spatial zoom level of the given tile, and a temporal zoom level of the given tile.

7. The method of claim 1, wherein the compositing the number of samples in the given one of the one or more tiles comprises reducing sample count by subdividing the given one of the one or more tiles at a zoom level that differs from a zoom level used to divide the samples into the one or more tiles.

8. The method of claim 7, wherein the compositing comprises temporal compositing comprising:
sorting the number of samples by sample time into sub-groups;
for each sub-group, selecting a last sample of the number of samples; and
forming the composited number of samples comprising each of the selected last samples from the sub-groups.

9. The method of claim 7, wherein the compositing comprises spatial compositing comprising:
sorting the number of samples by grid point into groups;
for each group, combining each sample; and
forming the composited number of samples comprising each of the combined samples from the groups.

10. The method of claim 1, wherein the processing of the transaction further comprises:
in response to a determination that a new tile contains composited samples, incrementing a zoom level at which the composited samples are divided; and
re-dividing the composited samples into one or more additional tiles at the incremented zoom level.

11. The method of claim 1, further comprising:
receiving, by the processing device, a read request related to the samples from the user device, the read request comprising at least one of a time range, a spatial range, a play rate, and a spatial zoom level; and
processing, by the processing device, the read request, the read request processing comprising:
determining one or more zoom levels at which to read the samples;
determining a set of tiles from which to read the samples;
reading the samples from the set of tiles; and
combining the read samples from the set of tiles.

12. The method of claim 11, wherein the one or more zoom levels is based on one or more of the time range, the spatial range, the play rate, and the spatial zoom level in the read request.

13. A system comprising:
at least one data processor;
a storage structure; and
memory storing instructions which, when executed by the at least one data processor, implement a method comprising:
receiving a storage request comprising samples from a user device in communication with the at least one data processor;
storing, in a database table of the storage structure, a transaction comprising a transaction structure representing the storage request, the transaction structure comprising a list of the samples;
processing the transaction to enable subsequent user read operations, the processing comprising:
dividing the samples into one or more tiles according to criteria based upon spatial and/or temporal factors of the samples and the one or more tiles;
in response to a determination that, for a given one of the one or more tiles, a number of samples exceeds a predefined threshold, compositing the number of samples in the given one of the one or more tiles; and
storing, in the storage structure, the composited number of samples.

14. The system of claim 13, wherein the storing of the transaction is in response to an initial validation that the storage request meets predefined criteria.

15. The system of claim 13, wherein the transaction structure further comprises one or more of an operation type and a valid flag.

16. The system of claim 13, wherein the memory storing instructions implement the method further comprising:
performing, in response to the storing of the transaction, a validation analysis of the transaction, the validation analysis comprising a determination as to the validity of one or more operation types associated with the samples.

17. The system of claim 13, wherein the criteria based upon spatial and/or temporal factors comprises a minimum zoom level, wherein the minimum zoom level comprises a spatial zoom level and/or a temporal zoom level at which the samples fit within a single one of the one or more tiles.

18. The system of claim 13, wherein the processing of the transaction further comprises indexing each of the samples with a tile index, wherein the tile index comprises a set of integers specifying, for a given tile corresponding to a particular one of the samples, one or more of a location of the given tile, a time dimension of the given tile, a spatial zoom level of the given tile, and a temporal zoom level of the given tile.

19. The system of claim 13, wherein the compositing the number of samples in the given one of the one or more tiles comprises reducing sample count by subdividing the given one of the one or more tiles at a zoom level that differs from a zoom level used to divide the samples into the one or more tiles.

20. The system of claim 19, wherein the compositing comprises temporal compositing comprising:
sorting the number of samples by sample time into sub-groups;
for each sub-group, selecting a last sample of the number of samples; and
forming the composited number of samples comprising each of the selected last samples from the sub-groups.

21. The system of claim 19, wherein the compositing comprises spatial compositing comprising:
sorting the number of samples by grid point into groups;
for each group, combining each sample; and
forming the composited number of samples comprising each of the combined samples from the groups.

22. The system of claim 13, wherein the processing of the transaction further comprises:
in response to a determination that a new tile contains composited samples, incrementing a zoom level at which the composited samples are divided; and
re-dividing the composited samples into one or more additional tiles at the incremented zoom level.

23. The system of claim 13, wherein the memory storing instructions implement the method further comprising:
receiving a read request related to the samples from the user device, the read request comprising at least one of a time range, a spatial range, a play rate, and a spatial zoom level; and
processing the read request, the read request processing comprising:
determining one or more zoom levels at which to read the samples;
determining a set of tiles from which to read the samples;
reading the samples from the set of tiles; and
combining the read samples from the set of tiles.

24. The system of claim 23, wherein the one or more zoom levels is based on one or more of the time range, the spatial range, the play rate, and the spatial zoom level in the read request.
